(19) United States
(12) Patent Application Publication
(10) Pub. No.: US 2025/0101207 A1
(43) Pub. Date: Mar. 27, 2025

(54) LIQUID SULFUR POLYMERS FOR IMPROVED TIRE CHARACTERISTICS

(71) Applicant: Bridgestone Americas Tire Operations, LLC, Nashville, TN (US)

(72) Inventor: Jared J. Griebel, Orange Village, OH (US)

(21) Appl. No.: 18/897,938

(22) Filed: Sep. 26, 2024

Related U.S. Application Data
(60) Provisional application No. 63/585,237, filed on Sep. 26, 2023.

(51) Int. Cl. C08L 9/00; B60C 1/00; C08K 3/36; C08K 5/3417

(52) U.S. Cl. CPC C08L 9/00; B60C 1/0016; C08K 3/36; C08K 5/3417; C08K 2201/006; C08L 2205/025; C08L 2205/035; C08L 2205/06; C08L 2207/322; C08L 2312/00

(57) ABSTRACT

A rubber composition is described that includes a rubber component in combination with a high surface area silica, and a polysulfide polymer having the following formula:

HS(C₂H₄—O—CH₂—O—C₂H₄SS)xC₂H₄—O—CH₂—O—C₂H₄SH

wherein x is 5 to 100. The rubber composition can be included in the tread of pneumatic tires to provide tires that exhibit improved mechanical and performance properties.

### CROSS-REFERENCE TO RELATED APPLICATIONS

This application claims the benefit of priority to U.S. provisional application 63/585,237, filed on Sep. 26, 2023, having the title “Liquid Sulfur Polymers for Improved Tire Characteristics.” This prior application is incorporated by reference herein for all purposes.

### TECHNICAL FIELD

This disclosure relates to liquid polysulfide polymers that can be used to improve the characteristics of a rubber composition. In particular, the liquid polysulfide polymers can be used to include the characteristics of a rubber composition including silica that is used in a pneumatic tire.

### BACKGROUND

Plasticizers play some important roles in formulating rubber. They can be used to improve processing, tackiness, dispersion, and flow of the unvulcanized compound. They can lower the modulus or improve the low temperature performance of the vulcanized compound.

Plasticizers include primary and secondary plasticizers. Primary plasticizers solubilize the rubber and assist in Brownian motion of the polymer chains, thus reducing the viscosity of the compound. Secondary plasticizers do not solubilize the elastomer, but they can act as lubricants between the polymer chains to improve flow.

Common plasticizers include petroleum oils, resins, synthetic plasticizers, or vegetable oils. Petroleum oils are often classified by their content of aromatic, paraffinic, and naphthenic hydrocarbons. In contrast with paraffinic oils, naphthenic oils contain only low to no proportion of n-alkanes, being based on cycloalkanes (naphthenes) instead.

In small quantities, for example, 5 to 20 parts per hundred parts of rubber by weight (phr), petroleum oils are used to improve flow and processing. Quantities of 10 to 40 phr are often used to soften the rubber and reduce the hardness and modulus. To extend the rubber, quantities of oil from 10 or 50 phr to more than 100 phr can be used.

It has been shown that plasticizers play an important role in pneumatic tire mechanical properties and performance. Improving the balance of these properties is a challenge. Accordingly, there is a need for novel plasticizer oil compositions that can improve mechanical properties, wet and snow performance, cornering coefficient properties, and/or wear performance.

### SUMMARY

As disclosed herein, polysulfide polymers are used as a partial replacement for petroleum or vegetable oil plasticizer/viscosity modifiers. Polysulfide polymers improve silica dispersion, act as a viscosity modifier, and crosslink into the polymer compound during final mixing/curing. An advantage of polysulfide polymers is that they are amphiphilic. This enables an interaction with highly polar silica and the non-polar polymer compound and enhances silica dispersion, which results in improved wet and snow performance and wear performance of tires. Furthermore, polysulfide polymer materials are low viscosity and low molecular weight, wherein such characteristics aid in decreasing the viscosity of highly loaded silica compounds. The polysulfide polymer materials are crosslinkable due to the thiol functionality within the polymer backbone. Because the polysulfide polymers crosslink into the rubber compound during the final mixing of the rubber, these materials exhibit improved mechanical properties.

In some aspects, the techniques described herein relate to a rubber composition, including: a rubber component; a reinforcing filler, the reinforcing filler including about 50 to about 120 phr of a silica having an N₂SA (BET) surface area of about 200 m²/g to about 400 m²/g, such as, e.g., 205 to 305 m²/g, or 210 to 300 m²/g, and about 1 to about 20 phr of a polysulfide polymer having the following formula:

HS(C₂H₄—O—CH₂—O—C₂H₄SS)xC₂H₄—O—CH₂—O—C₂H₄SH

wherein x is 5 to 100.

In some aspects, the techniques described herein relate to a pneumatic tire including a component including a rubber composition, the rubber composition including: a rubber component; a reinforcing filler, the reinforcing filler including about 50 to about 120 phr of a silica having an N₂SA (BET) surface area of about 200 m²/g to about 400 m²/g, such as, e.g., 205 to 305 m²/g, or 210 to 300 m²/g, and about 1 to about 20 phr of a polysulfide polymer having the following formula:

HS(C₂H₄—O—CH₂—O—C₂H₄SS)xC₂H₄—O—CH₂—O—C₂H₄SH

wherein x is about 5 to about 100.

In some aspects, the techniques described herein relate to a rubber composition, including: a rubber component; a reinforcing filler, the reinforcing filler including about 50 to about 120 phr of a silica, and about 1 to about 20 phr of a polysulfide polymer having the following formula:

HS(C₂H₄—O—CH₂—O—C₂H₄SS)xC₂H₄—O—CH₂—O—C₂H₄SH

wherein x is about 5 to about 100; wherein the polysulfide polymer has a crosslinking agent percentage of 0.4% by weight or less.

### BRIEF DESCRIPTION OF THE DRAWINGS

The above aspects and additional aspects, features and advantages will become readily apparent by describing in detail exemplary embodiments thereof with reference to the attached drawings:

FIG. 1A is reaction scheme I discussed below.

FIG. 1B is reaction scheme II discussed below.

FIG. 2 is a table showing results of a study of using a polysulfide in various rubber compositions with cure agent and other adjustments (Example 1).

FIG. 3 is a table showing results of a study with polysulfides and PVI as a scorch inhibitor (Example 2).

FIG. 4 is a table showing results of a study of a polysulfide compound LP-31 with a reduced amount of silica and varying amounts of naphthenic-based oil (Example 3).

FIG. 5 is a table showing results of a study of using a polysulfides in rubber compositions with Si-functional polybutadiene and Si-functional poly (styrene-butadiene) as a replacement for soybean oil (Example 4).

### DETAILED DESCRIPTION

The technology disclosed herein provides a rubber composition that includes a natural and/or synthetic rubber, a high surface area silica, and a polysulfide polymer having the following formula:

HS(C₂H₄—O—CH₂—O—C₂H₄SS)xC₂H₄—O—CH₂—O—C₂H₄SH

wherein x is about 5 to about 100. Particularly, the rubber composition can be included in the tread of a pneumatic tire to provide tires that exhibit improved mechanical properties, wet and snow performance, cornering coefficient properties, and wear performance. Ether linkages present in the polysulfide polymer impart hydrophilicity to improve an interaction with silica particles, while methylene carbons and mercaptan groups on the polysulfide interact with rubber and enable crosslinking.

The following discussion is presented to enable a person skilled in the art to make and use the invention. Various modifications will be readily apparent to those skilled in the art, and the general principles disclosed herein can be applied to other embodiments and applications without departing from the scope of the present invention as defined by the appended claims. Thus, the present invention is not intended to be limited to the embodiments shown, but is to be accorded the widest scope consistent with the principles and features disclosed herein.

“Bead” means a portion of a tire comprising an annular tensile member wrapped by ply cords and shaped, with or without other reinforcement elements such as flippers, chippers, apexes, toe guards and chafers, to fit a design rim.

“Belt structure” means at least two annular layers or plies of parallel cords, woven or unwoven, underlying the tread, unanchored to a bead, and having cords inclined respect to an equatorial plane of a tire. The belt structure can also include plies of parallel cords inclined at relatively low angles, acting as restricting layers.

“Carcass” means a tire structure apart from a belt structure, tread, undertread, and sidewall rubber over the plies, but including beads.

“Casing” means a carcass, belt structure, beads, sidewalls, and all other components of a tire excepting a tread and an undertread, i.e., an entirety of the tire.

The term “cured” is used interchangeably with the term “vulcanized” in conjunction with the cured rubber component of this invention and denotes that the rubber component to be vulcanized has been cured to a state in which the physical properties of the rubber are developed to impart elastomeric properties to the rubber generally associated with the rubber in its conventional vulcanized state.

“Fabric” means a network of essentially unidirectionally extending cords, which can be twisted, and which in turn are composed of a plurality of a multiplicity of filaments (which can also be twisted) of a high modulus material.

“Fiber” is a unit of matter, either natural or man-made that forms the basic element of filaments. It is characterized by having a length at least 100 times its diameter or width.

“Natural rubber” means naturally occurring rubber such as can be harvested from sources such as Hevea rubber trees and non-Hevea sources (e.g., guayule shrubs and dandelions such as TKS). The term “natural rubber” should be construed so as to exclude synthetic polyisoprene.

“Polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

“Polymer” includes both polymers of a single type of mer unit, and copolymers, which include polymers of two or more types of mer units. Functionalized polymers, e.g, end-functionalized or chain-functionalized polymers are also included in the general term polymer.

“Ply” means a cord-reinforced layer of rubber-coated radially deployed or otherwise parallel cords.

“Radial Ply Structure” means one or more carcass plies or which at least one ply has reinforcing cords oriented at an angle of between about 65 degrees and about 90 degrees with respect to an equatorial plane of a tire.

The term “rubber composition” as used herein refers to carbon black and/or silica filled natural and synthetic rubber systems, which can be cured so as to exhibit elastomeric properties. The term “elastomer” is used interchangeably with the term “rubber.”

“Sidewall” means a portion of a tire between a tread and a bead.

“Thermoplastic” as in the phrase “thermoplastic resin” is used to indicate a resin which softens upon heating and can generally be molded in its softened state.

“Tread” means a molded rubber component which, when bonded to a tire casing, includes a portion of the tire that comes into contact with a road when the tire is normally inflated and under normal load.

Unless otherwise stated, any molecular weight determination should be made by GPC, the rubber was dissolved in THF and 2 Tosoh TSK Gel GMHx1 columns were utilizing. Calibration can be made with polystyrene standards and the values calculated using Mark-Houwink coefficients.

The term “phr” as used in this specification is a term for quantitative amounts commonly used in the rubber industry for mixture formulations. “Phr” is an amount added in parts by weight of an individual substance based on 100 parts by weight of the entirety of rubber component present in a mixture.

In one example, the rubber composition incorporating the technology disclosed herein comprises: a natural rubber, synthetic rubber, or a natural rubber in combination with a synthetic rubber, a reinforcing filler comprising about 50 to about 120 phr of a high surface area silica, and about 1 to about 20 phr of a polysulfide polymer having the following formula:

HS(C₂H₄—O—CH₂—O—C₂H₄SS)xC₂H₄—O—CH₂—O—C₂H₄SH

wherein the value of x is about 5 to about 100, such as about 10 to about 60, about 20 to about 50, about 20 to about 25. The value of x is 22 to 27 repeat units for LP-12 and LP-55 and the value of x is 45 to 50 repeat units for LP-31.

In an embodiment, the polysulfide polymer is a polymer of bis-(ethylene oxy) methane containing disulfide linkages. The reactive terminal groups used for curing are mercaptans (—SH). In an embodiment, the polysulfide polymer may have a number average molecular weight less than about 15,000 g/mol and/or is a liquid at 25° C. For example, the polysulfide polymer may have a number average molecular weight of about 500 to about 10,000 g/mol, such as, for example, about 750 to about 7,000 g/mol, or about 2,000 to about 4,500 g/mol. The polysulfide polymer may have a weight average molecular weight less than about 25,000 g/mol.

The polysulfide polymer can include a crosslinking agent, if present, it is in an amount of about 0.01% to about 1% by weight of a sample, such as, for example, about 0.01% to about 0.4%, or about 0.1% to about 0.2%. The crosslinking agent trifunctional compound that allows for network formation. In an embodiment, the crosslinking agent is at least a trifunctional agent. The crosslinking agent is randomly incorporated along the polysulfide polymer chain.

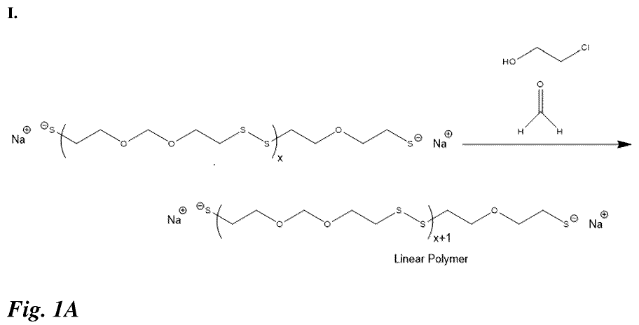

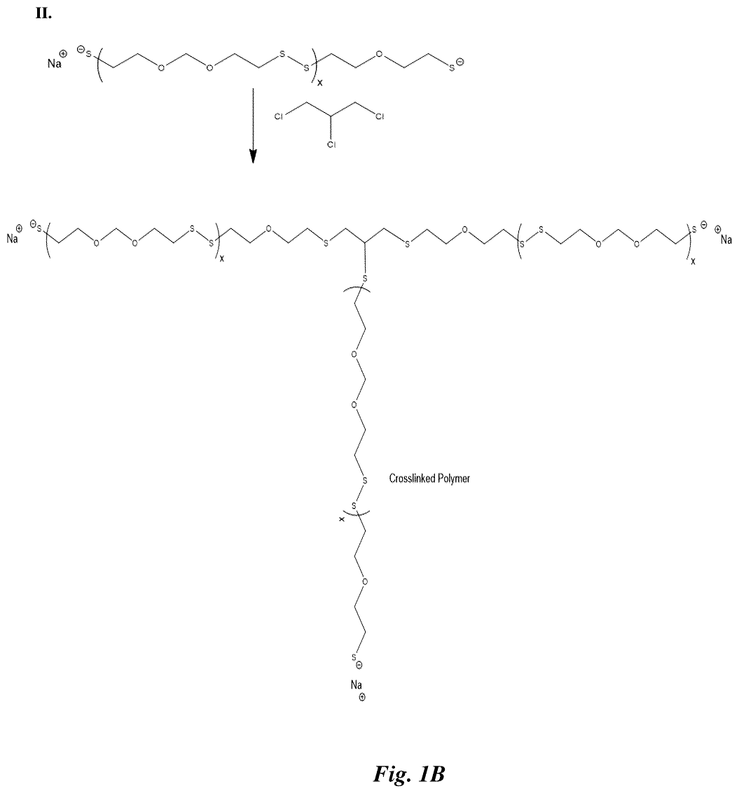

The polysulfide polymer can be made by reaction (I) (See FIG. 1A) to produce a linear polymer. The polysulfide polymer can be made and crosslinked with a crosslinking agent by reaction (II) (See FIG. 1B). In reaction I, an oxygen donating curing agent (2-chloroethanol and formaldehyde) are added to the bis-(ethylene oxy) methane containing polymer to oxidize the polymer's thiol (—SH) terminals to disulfide (—S—S-) bonds. Other oxygen donating reactants can be used, such as manganese dioxide, calcium peroxide, cumenehydroperoxide, and p-quinonedioxime. Lower valence metallic oxides, other organic hydroperoxides, metallic paint driers, and aldehydes can also function as curatives. In reaction II, a trifunctional cross-linking agent (trichloropropanol) is added to the bis-(ethylene oxy) methane containing polymer. This produces a crosslinked polysulfide polymer.

Polysulfide polymers can also be characterized by mercaptan content, which may be, for example, about 0.5 to about 15%, such as about 0.6 to about 12.5%, or about 1.6 to about 10% by weight. The polysulfide polymer may also have an average Brookfield viscosity at 25° C. determined by rheometer of, for example, about 0.1 to about 200 Pa*s, such as, about 1 to about 120 Pa*s, or about 10 to about 50 Pa*s. The polysulfide polymer may also have a pour point of about −30° C. to about 75° C., such as, for example, about 0° C. to about 70° C., or about 7 to about 30° C.

In an embodiment, the polysulfide polymer comprises at least one Thiokol™ liquid polysulfide or Thioplast® G from NOURYON B.V. In an embodiment, the polysulfide polymer can be selected from the group consisting of Thiokol™ Liquid Polysulfides LP-2, LP-3, LP-12, LP-31, and LP-55.

Examples of Thioplast® G include: G21, G1, G12, G22, G131, and G112, which have a molecular weight over 1,800 g/mol; and G44 and G4, which have a molecular weight under 1,800 g/mol. Thioplast G131 has an average molecular weight of about 5,200 to about 6,500 g/mol by SEC standard, branching of about 0.5 mol %, or, for example, about 0.2% to about 2%, or about 0.3% to about 0.8%, and a mercaptan content of about 1.0 to about 1.3%.

The polysulfide polymer may be present in the rubber composition in an amount of about 1 to about 20 phr, such as, for example, about 2 to about 12 phr, about 1 to 4 phr, or 6 to about 15 phr.

Combination of the polysulfide polymer with a high surface area silica was found to produce improved properties in a rubber compound. Examples of silica fillers suitable for use in embodiments disclosed herein include, precipitated amorphous silica, wet silica (hydrated silicic acid), dry silica (anhydrous silicic acid), fumed silica, calcium silicate and the like. Other suitable silica fillers for use in rubber compositions of certain embodiments include, but are not limited to, aluminum silicate, magnesium silicate (Mg₂SiO₄, MgSiO₃), magnesium calcium silicate (CaMgSiO₄), calcium silicate (Ca₂SiO₄ etc.), aluminum silicate (Al₂SiO₅, Al₄·3SiO₄·5H₂O), and aluminum calcium silicate (Al₂O₃.CaO₂SiO₂).

Precipitated amorphous wet-process, hydrated silica fillers are produced by a chemical reaction in water, from which they are precipitated as ultrafine, spherical particles, with primary particles strongly associated into aggregates, which in turn combine less strongly into agglomerates. In embodiments, the rubber composition comprises silica filler having a pH of about 5.5 to about 7.5, such as, for example, about 5.5 to about 6.8.

The high surface area silica disclosed for combination with the polysulfide polymer can have a Brunauer-Emmett-Teller (BET) surface area of about 200 m²/g and about 400 m²/g, such as for example, about 210 m²/g to about 350 m²/g, or about 260 to about 320 m²/g. The total amount of high surface area silica may be about 50 to about 120 phr, about 55 to about 100 phr, about 60 to about 90 phr, or about 65 to about 85 phr. The high surface area silica can be Hi-Sil EZ200G of PPG Industries, Inc. (PPG). In an embodiment, the high surface area silica is a precipitated silica. In another embodiment, the high surface area silica is a fumed silica. Some other commercially available silica fillers that can be used in the rubber compositions of certain embodiments disclosed herein include Hi-Sil® 190, Hi-Sil® 210, Hi-Sil® 215, Hi-Sil® 233, Hi-Sil® 243, and the like, produced by PPG Industries (Pittsburgh, Pa.). Certain of these may be used in addition to the high surface area silica, others may be used as the high surface area silica in some embodiments. Other silicas with lower surface area ranges are listed below that may be used as the reinforcing filler in some embodiments.

The rubber component used in the rubber composition with the polysulfide polymer and silica filler can be a natural rubber and/or a synthetic diene rubber. Examples of natural rubber include hevea natural rubber and guayule natural rubber, which each primarily compose isoprene monomers. Synthetic polymers include, for example, diene polymers, such as, styrene-butadiene rubber, polybutadiene rubber, and synthetic polyisoprene. Other rubber polymers may also be present in the composition.

Diene polymers comprise those polymers having rubber-like properties are prepared by polymerizing a conjugated C4 to C6 diolefin such as butadiene or isoprene. Either of these may be copolymerized with styrene, methyl styrene or acrylonitrile. In such case, the conjugated diolefin may be present to the extent of at least about 50%—based on the total of polymerizable material, such as about 75% to about 99%, or about 90% to about 98%. Other examples of rubber polymers are selected from the group consisting of diene rubbers, diene/alpha-olefin rubbers, ethylene/propylene rubbers and ethylene/alpha-olefin/diene rubbers (EPDM). An isobutylene-isoprene copolymer “butyl” rubber, as well as the elastomeric ethylene-propylene copolymers and terpolymers can also be used.

In an embodiment, the rubber polymer may contain one or more functional groups, including, for example, tin, silicon, and amine containing functional groups. The rubber polymers may be prepared by emulsion, solution, or bulk polymerization according to known suitable methods. In an embodiment, the rubber polymer may include a functional conjugated-diene polymer polybutadiene functionalized with a silicon containing group and/or styrene-butadiene polymer functionalized with a silicon containing group.

In an embodiment containing a blend of more than one polymer, the ratios (expressed in terms parts per hundred rubber (phr)) of such polymer blends can be adjusted according to the desired final viscoelastic properties for the rubber composition. For example, in an embodiment, natural rubber or polyisoprene may comprise about 5 to about 80 phr, such as about 20 phr to about 60 phr, or about 35 phr to about 55 phr or about 5 to about 20 phr; and polybutadiene, styrene-butadiene, or a combination of polybutadiene and styrene-butadiene rubber may comprise about 90 phr to about 20 phr, such as about 80 phr to about 50 phr, or about 70 phr to about 55 phr. In an embodiment, the rubber polymers are selected to include natural rubber, hi-cis polybutadiene, and styrene-butadiene polymer. In an embodiment, natural rubber or polyisoprene comprises: about 1 to about 20 phr of the rubber composition, such as, about 3 to about 15 phr, or about 7 to about 12 phr; about 25 to about 75 phr of hi-cis polybutadiene, such as, about 35 to about 65 phr, or about 45 to about 55 phr of hi-cis polybutadiene; and about 20 to about 60 phr of styrene-butadiene rubber, such as, about 25 to about 55 phr, or about 35 to about 45 phr of styrene-butadiene rubber. In an embodiment, one of the rubbers above is selected and comprises the entire rubber component. In an embodiment, the rubber component of the composition comprises natural rubber or polyisoprene, and polybutadiene, as well as styrene-butadiene polymer.

In an embodiment, these elastomeric polymers may contain one or more functional groups, including, for example, tin, silicon, and amine containing functional groups. The rubber polymers may be prepared by emulsion, solution, or bulk polymerization according to known suitable methods.

Hi-cis polybutadienes, are, for example, cis-1,4 polybutadiene having a cis-1,4-linkage content that is about 90% or greater, such as about 95% to about 99%, or about 96% to about 98%, where the percentages are based upon the number of diene mer units adopting the cis-1,4 linkage versus the total number of diene mer units. Also, these polymers may have a 1,2-linkage content that is less than, for example, about 5%, such as less than about 2%, or less than about 1%, and in other embodiments less than about 1%, where the percentages are based upon the number of diene mer units adopting the 1,2-linkage versus the total number of diene mer units. The balance of the diene mer units may adopt the trans-1,4-linkage. The cis-1,4-, 1,2-, and trans-1,4-linkage contents can be determined by infrared spectroscopy.

In an embodiment the rubber polymer, may have a number average molecular weight (Mn) of about 100,000 to about 1,000,000, such as about 150,000 to about 600,000, or about 250,000 to about 500,000. In an embodiment, the polydispersity of the rubber polymer (Mw/Mn) may be about 1.5 to about 6.5, such as about 2.0 to about 5.0, or about 2.5 to about 4.5.

Processing aids, such as petroleum oils, resins, synthetic plasticizers, or vegetable oils are often used in rubber compositions. In the present composition, if present, these may be used in a reduced amount of, for example, about 0.01 to about 20 phr, such as about 5 to about 15 phr, or about 1 to about 5 phr. In an embodiment, the composition is free of any free oil (oil added separately to the composition) or extender oil (oil added previously to polymers), or these are only present in a lower amount than typically used, for example, 20 phr or less, 15 phr to 3 phr, or 5 phr to 1 phr in total of both free oil and extender oil. The use of the polysulfide polymer as disclosed herein allows for exclusion of or lower than typical amounts of such processing aids. Use of processing aids may be reduced by, for example, about 2:1 to 1:1 ratio of plasticizer to polysulfide polymer, such as about 1.5:1 to about 1.1:1 or about 1.25:1 to about 1.1:1 ratio. For instance a reduction in a ratio of 2:1 would be for every 1 phr of polysulfide polymer, 2 phr of plasticizer can be removed from the composition. At about 1:1 replacement ratios processability of the composition can be substantially the same in terms of viscosity. Processability may be evaluated by Mooney viscosity of the compound at mixing temperatures, e.g., 150° C. In an embodiment, the wear life of a tire tread made with the rubber composition disclosed herein is improved. An improvement over a control rubber composition that is the same as the test composition except it replaces the polysulfide polymer with the same amount of a naphthenic-based oil may be for example, about 5% to about 20%, such as, for example, about 7% to about 18%, or about 10% to about 15%. This comparison can be based on a DIN abrasion test.

The comparative wear percentages provided herein refer to DIN abrasion values that can be measured using standard methods including DIN ISO 4649, 2017 edition, or more preferably DIN ISO 53516. According to such method, the values represent the amount of material lost (in mm³) during the abrasion testing. When comparing two DIN abrasion values, a lower number indicates less material lost and corresponds to an improvement in wear. An improvement in wear can also be described as improved resistance to abrasion and is generally desirable in a tire tread since it leads to a tire having a longer lifespan (e.g., having a higher predicted mileage rating). While a high surface area silica is discussed in detail herein, other reinforcing fillers may also be used in combination. In an embodiment, the other reinforcing filler may be selected from the group consisting of carbon black, another silica, and mixtures thereof. The total amount of reinforcing filler may be about 50 to about 150 phr, about 55 to about 120 phr, about 40 to about 95 phr, or about 50 to about 80 phr of filler.

Carbon black can be present in amounts ranging about 0 to about 80 phr, such as about 5 to about 60 phr, or about 20 to about 50 phr. The carbon black may have a nitrogen specific surface area (BET) of at least about 20 m²/g, such as, at least about 35 m²/g up to about 250 m²/g, such as 50 to 200 m²/g, or 60 to 150 m²/g.

Among the useful carbon blacks are furnace black, channel blacks and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks.

A mixture of two or more of the above blacks can be used in preparing the carbon black filled embodiments. The carbon blacks utilized in the preparation of the vulcanizable elastomeric compositions can be in pelletized form or an unpelletized flocculent mass.

A mixture of two or more of the above blacks can be used. Exemplary carbon blacks include, but are not limited to, N-110, N-220, N-339, N-330, N-352, N-550, and N-660, as designated by ASTM D-1765-82a.

Examples of other reinforcing silica fillers that can be used in addition to the high surface area silica include wet silica (hydrated silicic acid), dry silica (anhydrous silicic acid), and calcium silicate. The additional silica can be employed in an amount of about 1 to about 100 phr, or in an amount of about 5 to about 80 phr, or in an amount of about 30 to about 70 phr. The useful upper range is limited by the high viscosity imparted by fillers of this type. Some of the commercially available silicas that can be used include, but are not limited to, HiSil® 190, HiSil® 210, HiSil® 215, HiSil® 233, and Hisil® 243,produced by PPG Industries (Pittsburgh, Pa.). A number of useful commercial grades of different silicas are also available from DeGussa Corporation (e.g., VN2, VN3), Rhone Poulenc (e.g., Zeosil® 1165MPO), and J. M. Huber Corporation.

The surface area of the additional silicas may, for example, be about 32 m²/g to about 170 m²/g, such as about 100 m²/g to about 160 m²/g being preferred, or about 110 m²/g to about 150 m²/g, in an embodiment, 205 to 305 m²/g, or 210 to 300 m²/g,

A silica coupling agent is often desirable to couple the silica to the polymer. Numerous coupling agents are known, including but not limited to organosulfide polysulfides. Suitable organosilane polysulfides include, but are not limited to, 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricycloneoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl) tetrasulfide, 3-methoxyethoxypropoxysilyl 3′-diethoxybutoxy-silylpropyl tetrasulfide, 2,2′-bis(dimethylmethoxysilylethyl)disulfide, 2,2′-bis(dimethylsecbutoxysilylethyl)trisulfide, 3,3′-bis(methylbutylethoxysilylpropyl)tetrasulfide, 3,3′-bis(di t-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethylmethoxysilylpropyl)tetrasulfide, 3,3′-bis(ethyldi-secbutoxysilylpropyl)disulfide, 3,3′-bis(propyldiethoxysilylpropyl) disulfide, 3,3′-bis(butyldimethoxysilylpropyl) trisulfide, 3,3′-bis(phenyldimethoxysilylpropyl)tetrasulfide, 3′-trimethoxysilylpropyl tetrasulfide, 4,4′-bis(trimethoxysilylbutyl)tetrasulfide, 6,6′-bis(tricthoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis (dimethoxyphenylsilyl-2-methylpropyl) disulfide, and 3-octanoylthio-1-propyltricthoxysilane (NXT). Mixtures of organosilane polysulfide compounds can be used.

The amount of coupling agent in the composition is based on the weight of the silica in the composition. The amount of coupling agent present in the composition may be about 0.1% to about 20% by weight of silica, or about 1% to about 15% by weight of silica, or about 2% to about 10% by weight of silica. For example, typical amounts of coupling agents include about 4 to about 10, or about 6 to about 8 phr.

When both carbon black and silica are employed in combination as the reinforcing filler, they may be used in a carbon black-silica ratio of about 10:1 to about 1:10, such as about 5:1 to about 1:5, or about 2:1 to about 1:2.

Certain additional fillers may also be utilized, including mineral fillers, such as clay, talc, aluminum hydrate, aluminum silicate, magnesium silicate, aluminum hydroxide and mica. The foregoing additional fillers can be utilized in the amount of about 0.5 phr to about 40 phr, such as about 1 phr to about 30 phr, or about 5 phr to about 20 phr.

A rubber curing agent is included in the uncured rubber composition. Curing agents include, for example, vulcanization agents. For a general disclosure of suitable vulcanizing agents, one can refer to Kirk-Othmer, Encyclopedia of Chemical Technology, 3rd Ed., Wiley Interscience, N.Y. 1982, Vol. 20, pp. 365 to 468, particularly “Vulcanization Agents and Auxiliary Materials,” pp. 390 to 402. Vulcanizing agents can be used alone or in combination. In some embodiments, sulfur or peroxide-based vulcanizing agents may be employed. Examples of suitable sulfur vulcanizing agents include “rubber maker's” soluble sulfur; elemental sulfur (free sulfur); sulfur donating vulcanizing agents such as organosilane polysulfides, amine disulfides, polymeric polysulfides or sulfur olefin adducts; and insoluble polymeric sulfur. Other examples of additives for curing or accelerating vulcanization include sulfur chloride, sulfur thiocyanate, thiuram polysulfides, sulfonamides, thiosulfenamides and other organic or inorganic polysulfides.

Examples of suitable vulcanizing accelerators for use in certain embodiments disclosed herein include, but are not limited to, thiazole vulcanization accelerators, such as 2-mercaptobenzothiazole, 2,2′-dithiobis (benzothiazole) (MBTS), N-cyclohexyl-2-benzothiazole-sulfonamide (CBS), N-tert-butyl-2-benzothiazole-sulfonamide (TBBS); guanidine vulcanization accelerators, such as diphenyl guanidine (DPG); thiuram vulcanizing accelerators; and carbamate vulcanizing accelerators.

Vulcanization activators may also be included. Such activators are additives used to support vulcanization. Generally vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Generally, the amount of vulcanization activator used ranges from about 0.1 to about 6 phr, such as about 0.5 to about 4 phr, or about 1 to about 3 phr.

In one embodiment, the sulfur vulcanizing agent is soluble sulfur or a mixture of soluble and insoluble polymeric sulfur. The curing agent may be present in the composition at about 0.001 to about 10 phr, such as about 0.1 to about 4 phr, or about 0.5 to about 3 phr. Accelerators can be used in an amount of about 0.001 to about 10 phr, such as about 0.1 to about 6 phr, or about 1.5 to about 4 phr. The use of the polysulfide polymer as disclosed herein allows for use of lower than typical amounts of such accelerators. Use of accelerators may be reduced by, for example, to about 30% to about 90% of conventional amounts, such as, for example, about 50% to about 83%, or about 63% to about 80%. For instance, these reductions may equate to use of about 2.7 phr or less of accelerators, such as about 2.5 to about 1 phr, or about 2.3 phr to about 1.45 phr, or about 2.2 phr to about 1.8 phr.

In certain embodiments at least one rubber processing oil and/or a plasticizing resin is used in the rubber composition. According to certain embodiments when at least one oil is utilized, it will be added to a rubber-solvent-cement to extend the rubber polymer prior to mixing the polymer into the rubber composition. In other embodiments the rubber processing oil or resin can be added as a separate component to the mixer along with other components listed herein. In certain embodiments, the oil is a liquid at 25° C.

The rubber processing oil comprises at least one of: a plant oil, a petroleum oil, or a combination thereof. Thus, one or more than one plant oil can be utilized; one or more than one petroleum oil can be utilized; one plant oil and more than one petroleum oil can be utilized; or one petroleum oil and more than one plant oil can be utilized. Various types of petroleum oils may be suitable for use in certain embodiments of the first-fourth embodiments disclosed herein including aromatic, naphthenic, paraffinic, or low PCA petroleum oils. The phrase “low PCA” refers to those oils having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Suitable low PCA oils include mild extraction solvates (MES), treated distillate aromatic extracts (TDAE), TRAE, and heavy naphthenics. Suitable MES oils are available commercially as CATENEX SNR from SHELL, PROREX 15 and FLEXON 683 from EXXONMOBLE, VIVATEC 200 from BP, PLAXOLENE MS from TOTALFINAELF, TUDALEN 4160/4225 from DAHLEKE, MES-H from REPSOL, MES from Z8, and OLIO MES S201 from AGIP. Suitable TDAE oils are available as TYREX 20 from EXXONMOBIL, VIVATEC 500, VIVATEC 180 and ENERTHENE 1849 from BP, and EXTENSOIL 1996 from REPSOL. Suitable heavy naphthenic oils are available as SHELLFELX 794, ERGON BLACK OIL, ERGON H2000, CROSS C2000, CROSS C2400, and SAN JOAQUIN 2000L. Plant oils, as discussed below, will also generally qualify as low PCA.

Suitable plant oils for use in certain embodiments disclosed herein include those that can be harvested from vegetables, nuts, and seeds. Non-limiting examples of suitable plant oils for use in certain embodiments disclosed herein include, but are not limited to, soy or soybean oil, sunflower oil, safflower oil, corn oil, peanut oil, olive oil, grape seed oil, hazelnut oil, rice oil, safflower oil, sesame oil, mustard oil, flax oil, linseed oil, cotton seed oil, rapeseed oil, cashew oil, sesame oil, camellia oil, jojoba oil, macadamia nut oil, coconut oil, palm kernel oil, and palm oil. In certain embodiments, the oil comprises a combination of plant oils such as more than one of the foregoing plant oils; such a combination of plant oils is sometimes called a vegetable oil. In certain embodiments of the first-fourth embodiments disclosed herein, the oil comprises (includes) soybean oil. In certain embodiments of the first-fourth embodiments disclosed herein, the oil comprises (includes) sunflower oil; in certain such embodiments, the sunflower oil comprises high-oleic sunflower oil (e.g., having an oleic acid content of at least 60%, at least 70%, or at least 80% by weight oleic acid).

Resins used in the rubber composition may include phenolic resins and hydrocarbon resins such as cycloaliphatic resins, aliphatic resins, aromatic resins, terpene resins, and combinations thereof.

In one or more embodiments, useful hydrocarbon resins may be characterized by a glass transition temperature (Tg) of about 30 to about 160° C., in other embodiments about 35 to about 60° C., and in other embodiments about 70 to about 110° C. In one or more embodiments, useful hydrocarbon resins may also be characterized by its softening point being higher than its Tg. In certain embodiments, useful hydrocarbon resins have a softening point of about 70 to about 160° C., in other embodiments about 75 to about 120° C., and in other embodiments about 120 to about 160° C.

In certain embodiments, one or more cycloaliphatic resins are used in combination with one or more of an aliphatic, aromatic, and terpene resins. In one or more embodiments, one or more cycloaliphatic resins are employed as the major weight component (e.g. greater than about 50% by weight) relative to total load of resin. For example, the resins employed include at least about 55% by weight, in other embodiments at least about 80% by weight, and in other embodiments at least about 99% by weight of one or more cycloaliphatic resins.

In one or more embodiments, cycloaliphatic resins include both cycloaliphatic homopolymer resins and cycloaliphatic copolymer resins including those deriving from cycloaliphatic monomers, optionally in combination with one or more other (non-cycloaliphatic) monomers, with the majority by weight of all monomers being cycloaliphatic. Non-limiting examples of useful cycloaliphatic resins suitable include cyclopentadiene (“CPD”) homopolymer or copolymer resins, dicyclopentadiene (“DCPD”) homopolymer or copolymer resins, and combinations thereof. Non-limiting examples of cycloaliphatic copolymer resins include CPD/vinyl aromatic copolymer resins, DCPD/vinyl aromatic copolymer resins, CPD/terpene copolymer resins, DCPD/terpene copolymer resins, CPD/aliphatic copolymer resins (e.g., CPD/C5 fraction copolymer resins), DCPD/aliphatic copolymer resins (e.g., DCPD/C5 fraction copolymer resins), CPD/aromatic copolymer resins (e.g., CPD/C9 fraction copolymer resins), DCPD/aromatic copolymer resins (e.g., DCPD/C9 fraction copolymer resins), CPD/aromatic-aliphatic copolymer resins (e.g., CPD/C5 & C9 fraction copolymer resins), DCPD/aromatic-aliphatic copolymer resins (e.g., DCPD/C5 & C9 fraction copolymer resins), CPD/vinyl aromatic copolymer resins (e.g., CPD/styrene copolymer resins), DCPD/vinyl aromatic copolymer resins (e.g., DCPD/styrene copolymer resins), CPD/terpene copolymer resins (e.g., limonene/CPD copolymer resin), and DCPD/terpene copolymer resins (e.g., limonene/DCPD copolymer resins). In certain embodiments, the cycloaliphatic resin may include a hydrogenated form of one of the cycloaliphatic resins discussed above (i.e., a hydrogenated cycloaliphatic resin). In other embodiments, the cycloaliphatic resin excludes any hydrogenated cycloaliphatic resin; in other words, the cycloaliphatic resin is not hydrogenated.

In certain embodiments, one or more aromatic resins are used in combination with one or more of an aliphatic, cycloaliphatic, and terpene resins. In one or more embodiments, one or more aromatic resins are employed as the major weight component (e.g. greater than about 50% by weight) relative to total load of resin. For example, the resins employed include at least about 55% by weight, in other embodiments at least about 80% by weight, and in other embodiments at least about 99% by weight of one or more aromatic resins.

In one or more embodiments, aromatic resins include both aromatic homopolymer resins and aromatic copolymer resins including those deriving from one or more aromatic monomers in combination with one or more other (non-aromatic) monomers, with the largest amount of any type of monomer being aromatic. Non-limiting examples of useful aromatic resins include coumarone-indene resins and alkyl-phenol resins, as well as vinyl aromatic homopolymer or copolymer resins, such as those deriving from one or more of the following monomers: alpha-methylstyrene, styrene, orthomethylstyrene, meta-methylstyrene, para-methylstyrene, vinyltoluene, para (tert-butyl) styrene, methoxystyrene, chlorostyrene, hydroxystyrene, vinylmesitylene, divinylbenzene, vinylnaphthalene or any vinyl aromatic monomer resulting from C9 fraction or C8-C10 fraction. Non-limiting examples of vinylaromatic copolymer resins include vinylaromatic/terpene copolymer resins (e.g., limonene/styrene copolymer resins), vinylaromatic/C5 fraction resins (e.g., C5 fraction/styrene copolymer resin), vinylaromatic/aliphatic copolymer resins (e.g., CPD/styrene copolymer resin, and DCPD/styrene copolymer resin). Non-limiting examples of alkyl-phenol resins include alkylphenol-acetylene resins such as p-tert-butylphenol-acetylene resins, alkylphenolformaldehyde resins (such as those having a low degree of polymerization. In certain embodiments, the aromatic resin may include a hydrogenated form of one of the aromatic resins discussed above (i.e., a hydrogenated aromatic resin). In other embodiments, the aromatic resin excludes any hydrogenated aromatic resin; in other words, the aromatic resin is not hydrogenated.

In certain embodiments, one or more aliphatic resins are used in combination with one or more of cycloaliphatic, aromatic and terpene resins. In one or more embodiments, one or more aliphatic resins are employed as the major weight component (e.g. greater than about 50% by weight) relative to total load of resin. For example, the resins employed include at least about 55% by weight, in other embodiments at least 80% by weight, and in other embodiments at least about 99% by weight of one or more aliphatic resins.

In one or more embodiments, aliphatic resins include both aliphatic homopolymer resins and aliphatic copolymer resins including those deriving from one or more aliphatic monomers in combination with one or more other (non-aliphatic) monomers, with the largest amount of any type of monomer being aliphatic. Non-limiting examples of useful aliphatic resins include C5 fraction homopolymer or copolymer resins, C5 fraction/C9 fraction copolymer resins, C5 fraction/vinyl aromatic copolymer resins (e.g., C5 fraction/styrene copolymer resin), C5 fraction/cycloaliphatic copolymer resins, C5 fraction/C9 fraction/cycloaliphatic copolymer resins, and combinations thereof. Nonlimiting examples of cycloaliphatic monomers include, but are not limited to cyclopentadiene (“CPD”) and dicyclopentadiene (“DCPD”). In certain embodiments, the aliphatic resin may include a hydrogenated form of one of the aliphatic resins discussed above (i.e., a hydrogenated aliphatic resin). In other embodiments, the aliphatic resin excludes any hydrogenated aliphatic resin; in other words, in such embodiments, the aliphatic resin is not hydrogenated.

In one or more embodiments, terpene resins include both terpene homopolymer resins and terpene copolymer resins including those deriving from one or more terpene monomers in combination with one or more other (non-terpene) monomers, with the largest amount of any type of monomer being terpene. Non-limiting examples of useful terpene resins include alpha-pinene resins, beta-pinene resins, limonene resins (e.g., L-limonene, D-limonene, dipentene which is a racemic mixture of L-and D-isomers), beta-phellandrene, delta-3-carene, delta-2-carene, pinene-limonene copolymer resins, terpene-phenol resins, aromatic modified terpene resins and combinations thereof. In certain embodiments, the terpene resin may include a hydrogenated form of one of the terpene resins discussed above (i.e., a hydrogenated terpene resin). In other embodiments, the terpene resin excludes any hydrogenated terpene resin; in other words, in such embodiments, the terpene resin is not hydrogenated.

In certain embodiments, the amount of oil or resin used is about 1 to about 60 phr, such as, for example, 5 to about 50 phr, about 10 to about 40 phr, about 15 to about 35 phr, about 15 to about 25 phr, and about 20 to about 40 phr. In those embodiments where more than one of oil or resin is utilized, the foregoing ranges should be understood to apply to the total amount of oil(s) or the total amount of resin(s) separately.

The use of the polysulfide polymer as disclosed herein allows for use of lower than typical amounts of such processing oils and/or resins. Use of plasticizers may be reduced by, for example, to about 30% to about 90% of conventional amounts, such as, for example, about 40% to about 75%, or about 45% to about 70%. For instance, these reductions may equate to use of about 15 phr or less of plasticizing oils or resins, such as about 12.5 to about 3 phr, or about 10 phr to about 5 phr.

In an embodiment, an antidegradant is used to protect the rubber from the oxidation effects of atmospheric ozone. The amount of total antidegradant in the composition may be, for example, about 0.1 to about 15 phr, such as about 0.3 to about 6 phr, or about 2 phr to about 7 phr.

In an embodiment, the rubber composition disclosed herein may also contain additional components, such as those listed below, and in the following amounts:

Fatty acids, such as stearic acid: at about 0.001 to about 5 phr, such as about 0.1 to about 3.5 phr, or about 0.5 to about 2 phr.

Metal oxides, such as zinc oxide: at about 0.001 to about 10 phr, such as about 0.1 to about 5 phr, or about 0.5 to about 3 phr.

Examples of a cure retardant that can be mixed in the rubber composition of this embodiment include phthalic anhydride, benzoic acid, salicylic acid, N-nitrosodiphenylamine, a phthalimide retarder, such as N-(cyclohexylthio)-phthalimide (PVI), sulfonamide derivatives, diphenylurea, and bis (tridecyl) pentaerythritol diphosphate. Amounts that may be used are, for example, about 0.001 to about 5 phr, such as about 0.15 to about 3 phr, or about 0.18 to about 0.32 phr.

The compositions described herein can be used in a tire component of a pneumatic or non-pneumatic tire. A pneumatic tire comprises a tread; one pair of shoulders respectively continued to both sides with the tread part as a center; one pair of sidewalls respectively continued to the shoulders; one pair of beads respectively continued to the sidewalls; a body ply formed on the inner sides of the tread, shoulders, sidewalls and beads; a belt and a cap ply sequentially stacked between the inner side of the tread and the body ply; and an inner liner bonded to the inner side of the body ply. In the inner liner, a sheet including a rubber component is positioned at the part of the body ply corresponding to the shoulders and the sidewalls. A polymer film may be positioned at the part of the body ply corresponding to the tread. The tread can comprise a tread cap and a tread base, of which the rubber composition disclosed can be used in either. Other tire components that may incorporate the rubber composition disclosed here include, for example, subtread, bead filler, apex, chafer, sidewall insert, and wirecoat layers. An example of a tire manufacturing method is disclosed in U.S. Pat. No. 4,824,501, which is incorporated herein by reference.

### EXAMPLES

The technology will be further described by reference to the following detailed examples. These examples are offered to further illustrate the various specific and preferred embodiments and techniques. It should be understood, however, that many variations and modifications can be made while remaining within the scope of the present invention.

Several rubber compositions were made and tested. Each included the components listed in the Figures referenced below. All examples contained the same amounts of natural rubber, hi-cis polybutadiene, and styrene-butadiene polymer. Each was mixed and compounded according to the same procedure (unless otherwise stated).

### Example 1: Polysulfide Tested in Various Rubber Compositions with Cure Agent and Other Adjustments

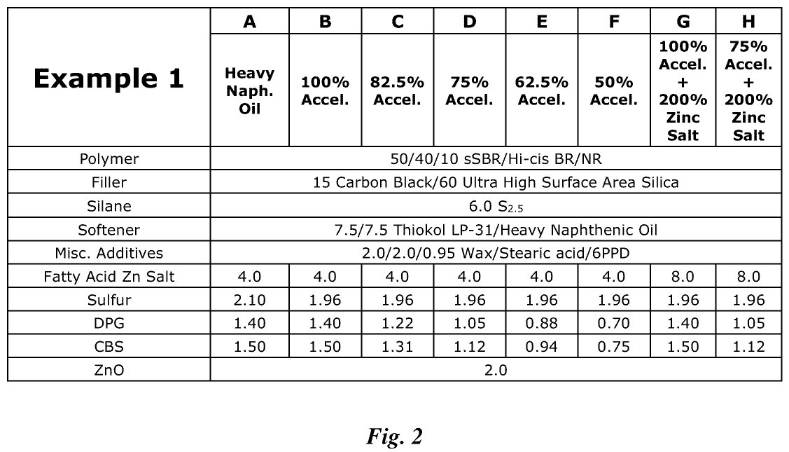

A study was conducted using LP-31 at a 50% replacement of naphthenic-based processing oil. Specifically, a mixture of 7.5 phr LP-31 and 7.5 phr of naphthenic-based oil was tested with a cure adjustment ranging from 50% to 100%. In this study, dibenzothiazyldisulfide (MBTS) was not included in a final curing stage. (See FIG. 2.)

It was observed that 62.5% and 50% cure packages improve scorch and match torque compared with results seen with a control compound. A rubber composition including a reduction to only 62.5% accelerator (1.8 phr) of a control at 100% (2.9 phr) accelerator consisting of DPG and CBS resulted in the best combination of mechanical properties, indices, wear performance, and scorch. Rolling resistance, cornering, tensile and elongation at break (Tb and Eb) were improved with the addition of the polysulfide material and traction values remained high.

### Example 2: Study Comparing LP-31 with LP-12 and LP-55 with a Cure Package Adjustment and an Investigation of PVI

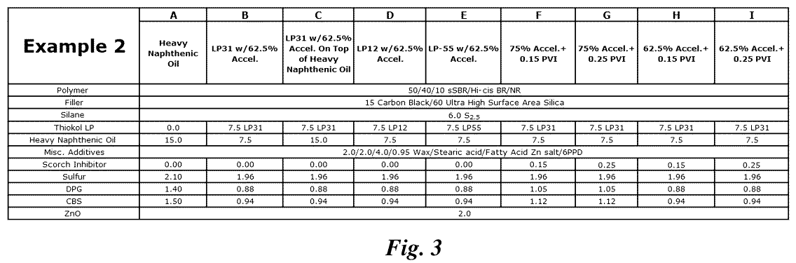

A second comparison study was conducted comparing LP-12 and LP-55, each at 50% replacement of naphthenic-based oil, to LP-31 at 50% replacement of naphthenic-based oil with a 62.5% cure package adjustment. (See FIG. 3.)

Compositions with LP-12 and LP-55 both showed a slight decrease in mechanical properties over LP-31. However, the indices were equivalent as between LP-12 and LP-55 to LP-31. LP-12 and LP-55 also demonstrated an increase in wear performance over LP-31.

Example 2-B compared to Examples 2-G and 2-H showed comparable mechanical properties; however, with the inclusion of PVI in Examples 2-G and 2-H there was an unexpected improvement in the wear property as well as an improvement in scorch.

### Example 3: Polysulfide with Reduced Silica PHR and Control Compounds without naphthenic-based oil

A study was performed including control compounds using commercially available silica having an N₂SA (BET) surface area of 288 m²/g with and without naphthenic-based oil. The silica also had the following properties: CTAB 200 m²/g and pH of about 7.0. Cornering and wear performance increased due to the higher stiffness of the compounds.

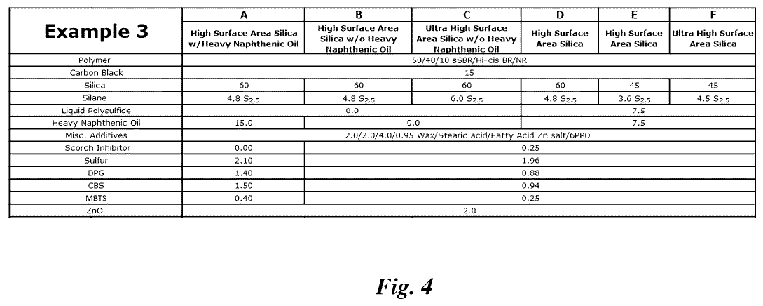

A commercially available high surface area silica was investigated in combination with LP-31. (Sec FIG. 4.) Additionally, a lower phr (45 phr versus 60 phr) of a commercially available high surface area silica was investigated with LP-31. Both of these compounds demonstrated a decrease in mechanical properties.

### Example 4: Study Comparing LP-31 with LP-55 replacement of Soybean Oil and using High Surface Area Silica and Ultra-High Surface Area Silica

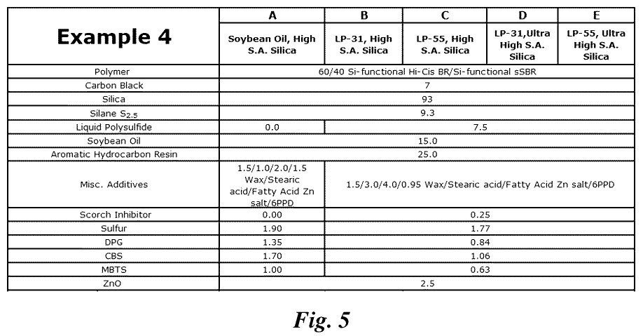

A fourth comparison study was conducted between LP-31 and LP-55, each at 50% replacement of liquid plasticizer, and a 93% adjustment in sulfur with a 62.5% cure package adjustment. (See FIG. 5.) The study was also performed including control compound using commercially available silica having an N₂SA (BET) surface area of 195 m²/g and CTAB 170 m²/g and pH of ˜7.0. Additionally, the study investigated the combination of LP-31 and LP-55 with a commercially available silica having an N₂SA (BET) surface area of 300 m²/g and CTAB 200 m²/g and pH of 7.0. The resulting compounds showed comparable compound viscosity. Wear property improvement was realized with a combination of LP-55 and the High Surface Area Silica (195 m²/g).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The term “consisting essentially” as used herein means the specified materials or steps and those that do not materially affect the basic and novel characteristics of the material or method. Unless the context indicates otherwise, all percentages and averages are by weight. If not specified above, the properties mentioned herein may be determined by applicable ASTM standards, or if an ASTM standard docs not exist for the property, the most commonly used standard known by those of skill in the art may be used. The articles “a,” “an,” and “the,” should be interpreted to mean “one or more” unless the context indicates the contrary.

What is claimed is:

1. A rubber composition, comprising:
a rubber component;
a reinforcing filler, the reinforcing filler comprising 50 to 120 phr of a silica having an N₂SA (BET) surface area of about 200 m²/g to about 400 m²/g, and 1 to 20 phr of a polysulfide polymer having the following formula:
HS(C₂H₄—O—CH₂—O—C₂H₄SS)xC₂H₄—O—CH₂—O—C₂H₄SH
wherein x is 5 to 100; and
20 phr or less of oil.

2. The rubber composition of claim 1, wherein the silica has an N₂SA (BET) surface area of about 210 m²/g and about 305 m²/g.

3. The rubber composition of claim 1, wherein the polysulfide polymer has a value of x that is about 20 to about 50.

4. The rubber composition of claim 1, wherein the polysulfide polymer has a crosslinking agent percentage of 0.4% by weight or less.

5. The rubber composition of claim 1, wherein the rubber composition further comprises an accelerator in an amount of about 0.5 to 4 phr.

6. The rubber composition of claim 1, wherein the polysulfide polymer has a mercaptan content of about 1.6 to about 15% by weight.

7. The rubber composition of claim 1, wherein the rubber component comprises a functional conjugated-diene copolymer.

8. The rubber composition of claim 1, wherein the rubber composition comprises about 6 to about 15 phr of the polysulfide polymer.

9. The rubber composition of claim 1, wherein the rubber composition comprises a rubber plasticizer in an amount of about 1 to 12 phr.

10. The rubber composition of claim 1, wherein the rubber composition further comprises a phthalimide cure retarder in an amount of about 0.001 to about 5 phr.

11. The rubber composition of claim 1, wherein the polysulfide polymer has a Brookfield viscosity of about 1 to about 120 Pa*s at 25° C.

12. A pneumatic tire including a component comprising
a rubber composition, the rubber composition comprising:
a rubber component;
a reinforcing filler, the reinforcing filler comprising 50 to 120 phr of a silica having an N₂SA (BET) surface area of about 200 m²/g to about 400 m²/g; and
1 to 20 phr of a polysulfide polymer having the following formula:
HS(C₂H₄—O—CH₂—O—C₂H₄SS)xC₂H₄—O—CH₂—O—C₂H₄SH
wherein x is 5 to 100.

13. The pneumatic tire of claim 12, wherein the component is a tread, and the tread comprises a tread cap and a tread base, and the rubber composition is the tread cap.

14. The pneumatic tire of claim 12, wherein the silica has an N₂SA (BET) surface area of 205 M²/g to 305 M²/g.

15. The pneumatic tire of claim 12, wherein the polysulfide polymer has a crosslinker percentage of 0.4% by weight or less.

16. The pneumatic tire of claim 12, wherein the rubber component comprises natural rubber or polyisoprene, polybutadiene having a cis content of 90% or greater, and styrene-butadiene polymer.

17. The pneumatic tire of claim 16, wherein the natural rubber or polyisoprene is present in an amount of 5 to 20 phr, the polybutadiene is present in an amount of 40 to 60 and the styrene-butadiene polymer is present in an amount of 30 to 50 phr.

18. The pneumatic tire of claim 12, wherein the rubber composition is in a tread of the pneumatic tire, and the tread has a wear improvement of about 5% to about 20% based on a DIN abrasion test over a control that is the same but replaces the polysulfide polymer with a naphthenic-based oil.

19. The pneumatic tire of claim 12, wherein the rubber composition comprises 6 to about 15 phr of the polysulfide polymer.

20. A rubber composition, comprising:
a rubber component;
a reinforcing filler, the reinforcing filler comprising 50 to 120 phr of a silica, and
1 to 20 phr of a polysulfide polymer having the following formula:
HS(C₂H₄—O—CH₂—O—C₂H₄SS)xC₂H₄—O—CH₂—O—C₂H₄SH
wherein x is 5 to 100;
wherein the polysulfide polymer has a crosslinking agent percentage of 0.4% by weight or less.
